(19) United States
(12) Patent Application Publication
(10) Pub. No.: US 2002/0164242 A1
(43) Pub. Date: Nov. 7, 2002

(54) Control system for transfer and buffering

(76) Inventors: Brian Wehrung, San Jose, CA (US); Barton J. Cox, Fremont, CA (US)

Correspondence Address: Mark E. Miller, Esq., O'MELVENY & MYERS LLP, 275 Battery Street, San Francisco, CA, 94111-3305, US

(21) Appl. No.: 10/056,158

(22) Filed: Jan. 24, 2002

Related U.S. Application Data
(60) Provisional application No. 60/264,557, filed on Jan. 26, 2001.

(51) Int. Cl. B65G 49/07

(52) U.S. Cl. 414/935; 700/214; 414/266; 414/273

(57) ABSTRACT

A control system for transferring and buffering material in a material transport system. A transport system and method for moving an article between a conveyor and a workstation. A robot works in conjunction with transportation buffer control system to move Pods between storage shelves, load ports and I/O ports without intervention of the material handling controller. The robots include vertical movement mechanisms and horizontal movement mechanisms together with gripping devices to handle the Pods. Movement of Pods between storage shelves, load ports and I/O ports is seen as a single activity by the material control system.

### RELATED APPLICATIONS

This application claims priority to the provisional application, serial No. 60/264,557, filed on Jan. 26, 2001.

### FIELD OF THE INVENTION

The present invention relates generally to manufacturing control systems and, particularly, to control systems for use in material transport.

### BACKGROUND OF THE INVENTION

In semiconductor manufacturing, semiconductor wafers must be safely transported between work stations and the like without damaging or destroying the wafers. Numerous other articles also require careful handling, including, but not limited to, pharmaceuticals, medical systems, flat panel displays, computer hardware such as disc drive systems, modems and the like. Semiconductor wafers must be retained in a clean room environment during processing to preserve the purity of the layers deposited on the wafer. The requirement of a clean room environment places additional constraints on the handling of semiconductor wafers. For additional protection against contaminants, the semiconductor wafers are typically retained in sealed transport containers as they are moved throughout the manufacturing facility in order to minimize any exposure to the environment outside of the processing machines. At various points during fabrication, semiconductor wafers are transported in a container via an automated conveyor system. Containers must be temporarily removed from the conveyor system at various intervals to process the semiconductor wafers. Preferably during the time a container is removed from the conveyor system, the operation of the conveyor system is not disrupted. After processing of the semiconductor wafers has been completed, the container must be carefully returned to the conveyor system for transport to the next work station. Preferably, return of the container to the conveyor system does not disrupt the operation of the conveyor system.

Automated conveyor systems are used in a variety of applications to transport material. Conveyor systems for transportation of containers such as, U.S. Pat. No. 6,223,886 filed Jun. 24, 1998, incorporated herein by reference, are generally known in the art. Material is typically loaded onto the conveyor using automated equipment which controls the flow of the material. Automated equipment is also used to remove the material at an exit point, with the conveyor and/or removal equipment being designed to allow several articles to accumulate near the exit while preventing collisions between adjacent material units. With some applications, including semiconductor processing, the material must be temporarily moved from the conveyor to a load port or a buffer station at one or more locations along the conveyor path. The material is later returned to the conveyor, which then transports the material to the next work station or an exit point. Moving the material between the conveyor and work stations can be complicated and care must be taken to ensure transfers are accomplished without significantly interrupting the flow of material on the conveyor or damaging the wafers.

Currently, in semiconductor manufacturing facilities, vehicle-based monorail systems are used to transport containers. In such systems, the vehicle is used for transportation and loading. During loading, the containers are raised from and lowered onto load ports directly from the monorail system via a hoist. During the time a container is raised or lowered, other containers on the monorail are prevented from moving past the point at which the specific container is being raised and lowered. Thus, the transport system is blocked at any point where a given container is being raised or lowered.

Control systems have been used for several years to control conveyor systems and have been specifically adapted for use in various systems. In particular, U.S. Pat. No. 6,240,335, filed Dec. 14, 1998, incorporated herein by reference, describes an automated control system for use in semiconductor manufacturing. In known systems, the global material control system precisely monitors and determines the movement of each container at all times, whether the container is on the main conveyor system or located at a given work or buffer station. This places a significant burden on the global material control system. A control system for efficiently and conveniently controlling the transfer of material between a conveyor system and a work station or buffer station or between various stations within the conveyor system, without interfering with conveyor material flow, is desirable.

### SUMMARY OF THE INVENTION

The present invention provides a control system for use in material transport systems. In particular, the present invention provides a control system for transferring and buffering containers in a semiconductor manufacturing facility. The invention provides a transport and buffering system for transporting containers between a conveyor and load ports and storing containers on shelves temporarily.

The present invention is directed at a transport and buffering control system that works in conjunction with transport robots and the material control system to move container between storage shelves, load ports and I/O ports. Movement of Pods between storage shelves, load ports and I/O ports is seen as a single activity performed by the material control system.

### BRIEF DESCRIPTION OF THE DRAWINGS

FIG. 1 is a high level view of the transport control system including a transport and buffering control system.

FIG. 2 is a high level view of a transport and buffering control system.

FIG. 3 is an alternate high level view of a transport and buffering control system.

FIG. 4 shows the logical associations of the transport and buffering systems and its association with the transport controller.

FIG. 5 shows engaged and disengaged positions of pod relative to a location.

FIG. 6A shows command and data flow within the transport and buffering control system.

FIG. 6B is a continuation of command and data flow diagram shown in FIG. 6A.

### DETAILED DESCRIPTION

The present invention is described herein with reference to a few specific embodiments. The present description uses the following terms:

Glossary of Terms

| Term | Definition |
|---|---|
| AMHS | Automated material handling system |
| CAN | Controller area network. Standard for networking embedded |
| | devices together. |
| Container | Generic term used to refer to an Cassette, Box or Pod. A |
| | container is that object which is transported by the |
| | Transport System. |
| CLC | Control logic computer. Hardware Platform for the mid-tier |
| | software components. |
| Intelligent | Hardware platform containing a local microcontroller and |
| Driver Board | network support (e.g., CAN bus support) used to monitor or |
| | control devices. |
| E15 | SEMI specification E-15 describing the mechanical |
| | interface for wafer carrier transfer between wafer carrier |
| | material transport systems and the placement and orienta- |
| | tion of a wafer carrier on a tool. |
| E23 | SEMI specification E23 defining multi-wire, parallel hand- |
| | shake for material handoffs between two devices. |
| E84 | SEMI specification E84 defining multi-wire, parallel hand- |
| | shake for material handoffs between two devices. |
| Fab | Facility used for manufacture of semiconductor devices. |
| FOUP | Front opening unified pod. A front opening Pod that may |
| | contain 300 mm wafers. |
| Handshake | Software application running on a parallel I/O board. |
| Controller | Implements a SEMI E23 or E84 interface with another |
| | device (e.g., a LPTD and Load Port). |
| I/O Port | An interface between the control system for transport and |
| | buffering and an external system. The I/O port is a resource |
| | shared between the transport and buffering system and an |
| | external transportation system. |
| LAN | Local area network. |
| Load Port | A location complying with E15 that the control system for |
| | transfer and buffering will service. Each load port has an |
| | associated E23 or E84 interface. |
| Location | Specific coordinates where the control system for transfer |
| | and buffering may acquire or deposit material. Three types |
| | of Locations are Load Ports, I/O Ports and Static Buffers. |
| Micro- | A computer module embedded in the conveyer used for |
| Controllers | control of the electro-mechanical systems. |
| Material | Generic term which, in this context, refers to semiconductor |
| | WIP or Reticles or any other articles that can be moved in a |
| | transport system. |
| MCS | Material control system |
| Parallel I/O | Hardware platform supporting 8 and optionally 16 bits of |
| Board | digital I/O. Used to implement SEMI E23 or E84 interface |
| | for a Handshake Controller. |
| Pod | A generic term describing a container that is transported by |
| | the Transportation System. A Pod may be a SMIF Pod, |
| | FOUP or any other container used to transport Material. |
| Static Buffer | Simple immobile platforms in which Material or Pods may |
| | be staged or stored. |
| SMIF Pod | Standard Mechanical Interface Pod. May contain reticules |
| | or WIP in a controlled mini-environment. SMIF Pods are |
| | bottom opening and are not used for 300 mm wafers |
| | (see FOUP). |
| TBCS | Transport and buffering control system. |
| TBS | Transport and buffering system. |
| TC | Transport controller. Software system which is in charge of |
| | high level, non real time functions including external |
| | interfaces and inter-component coordination. |
| Transport | Generic term applied to a system which moves material |
| System | from point to point within a fab. |
| WIP | Work in progress. Typically applied to a semiconductor |
| | wafer in the process of being fabricated. |
| Zone | That section of track that can start, stop and transfer a |
| | single carrier. A zone is at least as long as a carrier. For a |
| | 300 mm fab, a zone shall be 500 mm in length. |

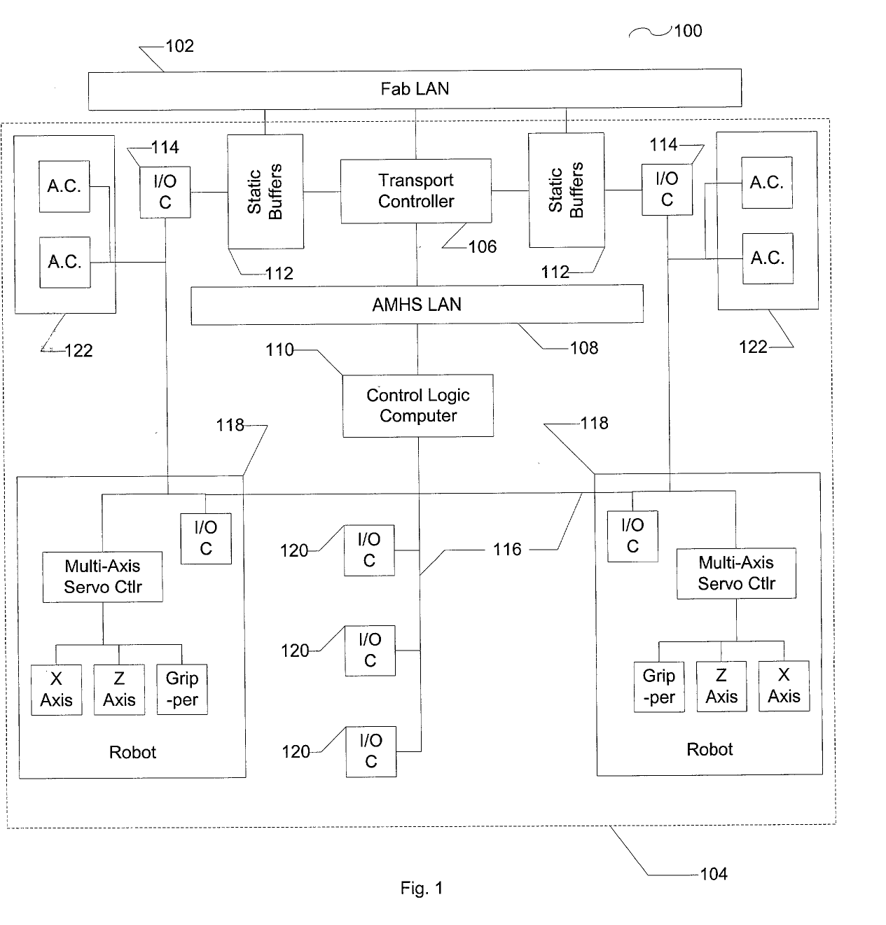

FIG. 1 shows a high level view of a semiconductor manufacturing transport control system 100. The semiconductor manufacturing transport control system 100 includes a Fab LAN 102 that is connected to a TBCS 104. A TC 106 is able to exchange data with both the Fab LAN 102 and an AMHS LAN 108. The AMHS LAN 108 is connected to a CLC 110 which receives command input instructions from the TC 106 via the AMHS LAN 108. The CLC 110 is also capable of exchanging data with the AMHS LAN 108.

Static Buffers 112 are capable of storing a plurality of Pods (not shown) in multiple rows and columns. The storage systems for the Static Buffers 112 can also exchange data directly with the Fab LAN 102. Each Static Buffer is connected to at least one I/O controller 114 and each I/O controller 114 has inputs to accept output of sensors on the static buffers 112. In one embodiment, each I/O controller 114 has an E84 interface. However, alternate embodiments are contemplated.

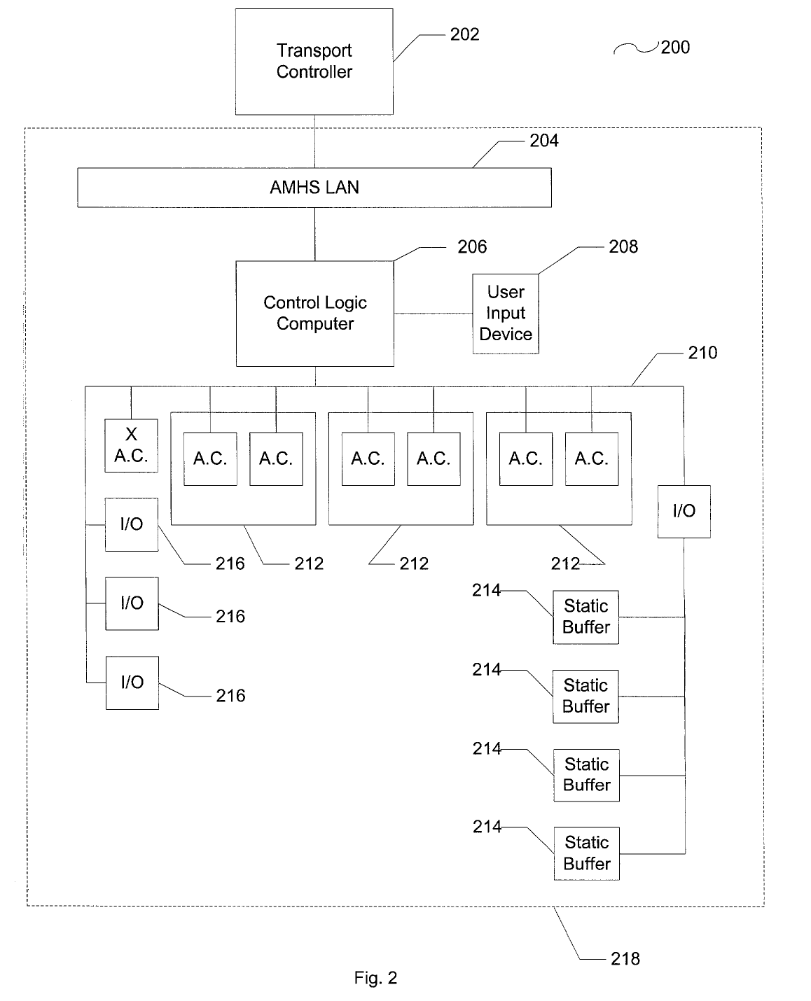

The CLC 110 is connected to a CAN bus 116. The CAN bus 116 is connected to a plurality of robot controllers 118, a plurality of load ports 120, and a plurality of I/O ports 122. Each robot controller 118 is capable of moving an associated robot (not shown) rectilinearly along at least two perpendicular axes and controlling a gripper capable of engaging a Pod. Each robot also has an associated sensor capable of determining whether a Pod is engaged by the robot. Although the system is described in FIGS. 1 and 2 as utilizing a CAN bus, alternate network protocols may be used.

Each load port 120 has an E23 or E84 interface to send and receive data to and from the CLC 110. In addition, each load port 120 has a standard interface required by a specific tool to be used at that given load port 120. In the preferred embodiment, load ports 120 are equipped with E84 interfaces to the tools.

Each I/O port 122 is an interface between the TBCS 104 and the transport control system 100 and is a resource shared by both the TBS 104 and the transport control system 100.

FIG. 2 depicts an alternative high level view of a manufacturing transport conveyor system 200 for use in a semiconductor manufacturing facility. The manufacturing transportation system 200 includes a TC 202 that controls the movement of Pods in a particular zone of the conveyor system or through the entire conveyor system. The TC 202 is coupled to and directs the flow of Pods along an AMHS LAN 204. A CLC 206 is coupled to the AMHS LAN 204. The CLC 206 may receive input commands from the TC 202 or a user input device 208. Additionally, the CLC 206 is capable of exchanging data with both the AMHS LAN 204 and the TC 202.

The CLC 206 is coupled to a CAN bus 210. The CAN bus 210 is coupled to a plurality of I/O ports 212, a plurality of Static Buffers 214 each having a Pod-in-place sensor (not shown), and plurality of Load Ports 216 each having an E23 or E84 interface (not shown). The CLC 206 is also operatively associated with multiple transport robots (not shown) capable of transporting Pods between the I/O ports 212, Static Buffers 214 and load ports 216. The CLC 206 is responsible for providing atomic level operations commands to the transport robots and compiling location information for Pods under the control of the CLC 206.

Each I/O port 212 is a resource shared by both the CLC 206 and under the control of both the CLC 206 and the manufacturing transportation system 200. Each I/O port 212 serves as an interface between the TBCS 218, which includes the CLC 206, User Input Device 208, I/O Ports 212, Static Buffers 214 and Load Ports 216, and the external transportation system (not shown).

The Static Buffers 214 are accessible by the TBCS 218. The Static Buffers 214 serve as intermediate storage locations between load ports 216 and I/O ports 212. Each Static Buffer 214 has a Pod-in-Place sensor. The Static Buffers 214 provide Pod-in-Place data to the TBCS 218.

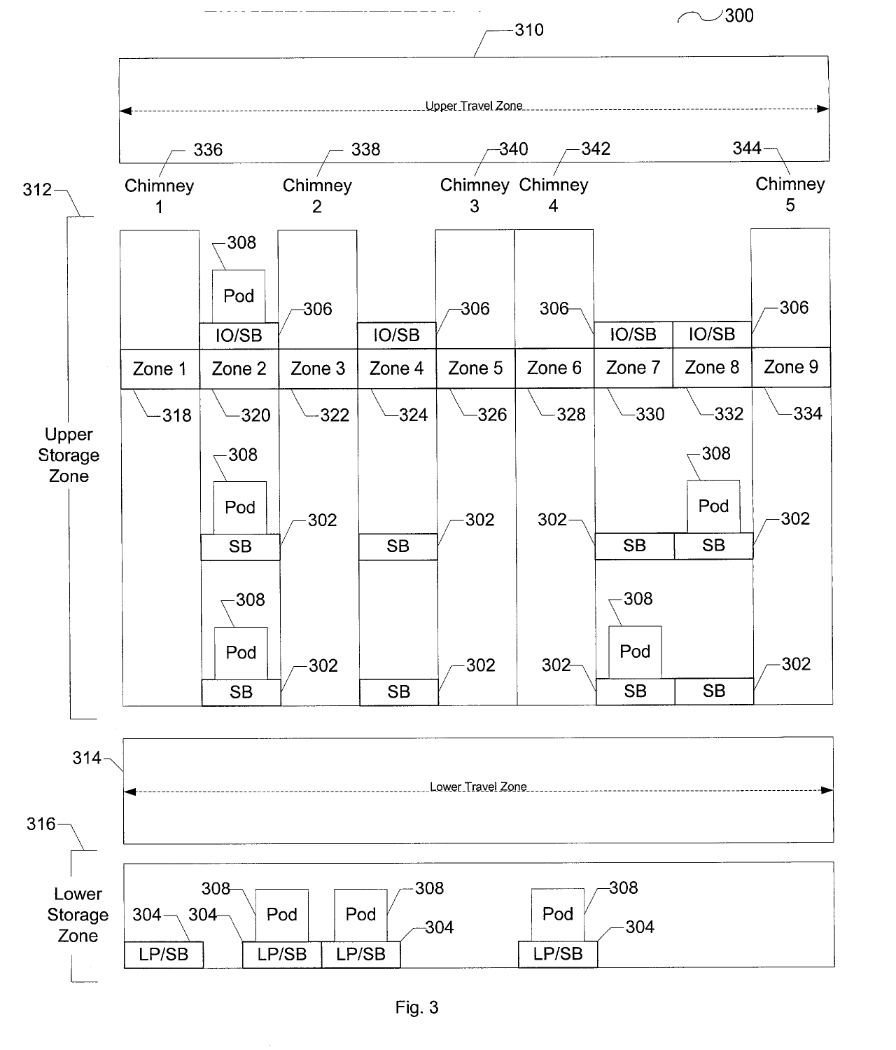

FIG. 3 shows one example of a physical embodiment of the transport and buffering system 300. The transport and buffering system includes a plurality of Static Buffers 302, load ports 304 and transfer stations or I/O ports 306-all collectively known as locations. The transport and buffering system also includes a plurality of transport robots (not shown) which are capable of transporting Pods 308 between the Static Buffers 302, load ports 304, and I/O ports 306. As shown, specific locations may be both load ports 304 and Static Buffers 302, while other locations may be both I/O ports 306 and Static Buffers 302.

FIG. 3 is one embodiment of the transport and buffering system. FIG. 3 is vertically divided into four regions, an upper travel zone 310, an upper storage zone 312, a lower travel zone 314 and a lower storage zone 316. The upper travel zone 310 and the lower travel zone 314 are used specifically for transportation of Pods 308. Storage of Pods 308 occurs only in the upper storage zone 312 and the lower storage zone 316. However, a Pod 308 may be transported horizontally within the upper storage zone 312 or the lower storage zone 316, when transportation of a Pod 308 is required between adjacent locations.

The upper storage zone 312 and the lower travel zone 314 are divided vertically into nine zones—zone 1 318, zone 2 320, zone 3 322, zone 4 324, zone 5 326, zone 6 328, zone 7 330, zone 8 332, and zone 9 334. The upper travel zone 310 has five chimneys—chimney 1 336, chimney 2 338, chimney 3 340, chimney 4 342, and chimney 5 344. Chimney 1 336 is aligned with zone 1 318, chimney 2 338 is aligned with zone 3 322, chimney 3 340 is aligned with zone 5 326, chimney 4 342 is aligned with zone 6 328, and chimney 5 344 is aligned with zone 9 334. The chimneys 336-344 allow Pods 308 to be vertically transported between the upper travel zone 310, upper storage zone 312, lower travel zone 314, and the lower storage zone 316. FIG. 3 is one embodiment of the transport and buffering system. Alternate embodiments of the transport and buffering systems that have varying numbers of chimneys, various lengths, and various quantities and locations of static buffers are contemplated.

For example, if the Pod 308 located in the lower storage zone 316 at the interface of zone 2 320 and zone 3 322 were to be moved to the middle Static Buffer located in the upper storage zone 312 of zone 4 342, the Pod 308 would first be engaged by a robot (not shown) and lifted vertically into the lower travel zone 314. The robot would then transport the Pod 308 horizontally within the lower travel zone until it was approximately aligned with zone 3 322 or chimney 2 338. The robot would then transport the Pod 308 vertically within chimney 2 338 until it reached an elevation slightly above that of the target Static Buffer. The robot would then transport the Pod 308 horizontally to align the Pod with the Static Buffer. The robot would finally lower the Pod 308 onto the Static Buffer and disengage the Pod 308.

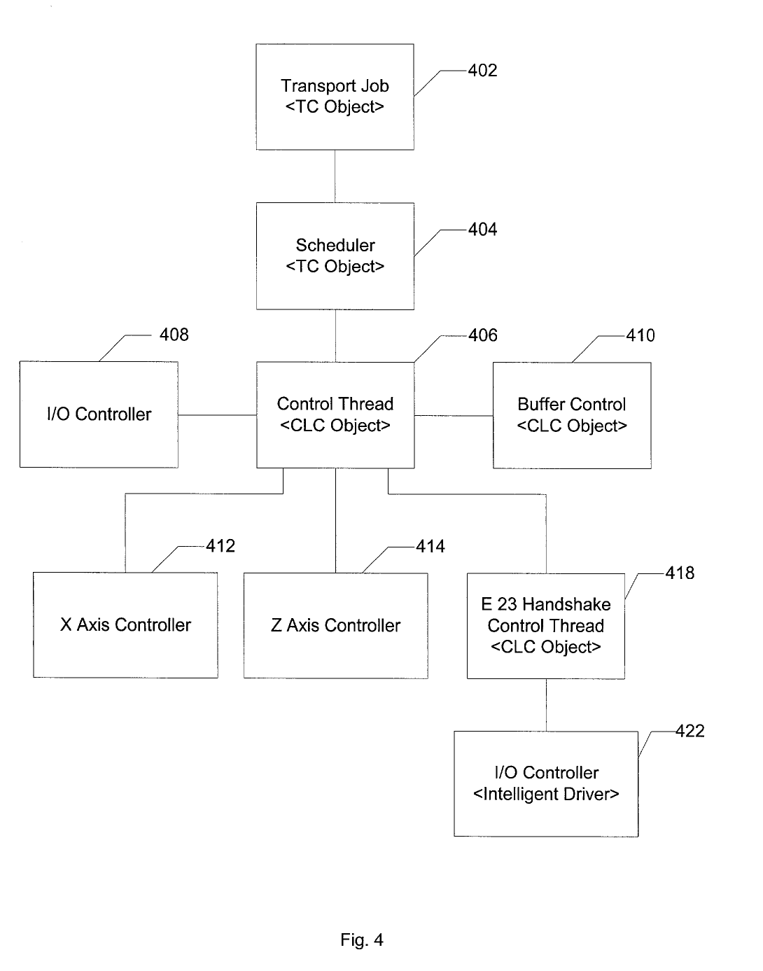

FIG. 4 shows a logical view of the TBCS together with its interfaces with the TC. The TC identifies a Transport Job as a specific object 402 and submits the Transport Job to the Scheduler 404. In one embodiment, the Scheduler 404 is also an object of the TC, not the CLC. However, in alternate embodiments, the Scheduler 404 may be an object of the CLC controller. The Scheduler 404 is responsible for sequencing the movement of Pods from location to location, but does not control the atomic level operations of the robot controllers. The Scheduler may employ any known scheduling algorithm to sequence the movement of Pods. The Scheduler may use a priority based First-In-First-Out algorithm to sequence movement of the Pods.

The Control Thread 406 is a CLC object that receives commands from the Scheduler 404 and issues atomic level commands to the transport robot, such as acquire, move, deposit and transfer operations. The Scheduler 404 also communicates with the I/O Controller 408 and exchanges data with Buffer Control 410 regarding position and status of Pods located in Static Buffers.

The Control Thread 406 controls a transport robot via an x-axis controller 412 and a z-axis controller 414. Furthermore, the Control Thread 406 may issue commands to establish communications between the Control Thread 406 and the external transport control system for hand-off of a Pod from the TBS to the load port.

The Handshake Control 416 is able to communicate with the CLC object E23 or E84 Handshake Control Thread 418. Furthermore, the E23 or E84 Handshake Control Thread 418 is able to receive data from the I/O Controller 422 regarding the Pod-in-Place status of a given I/O port.

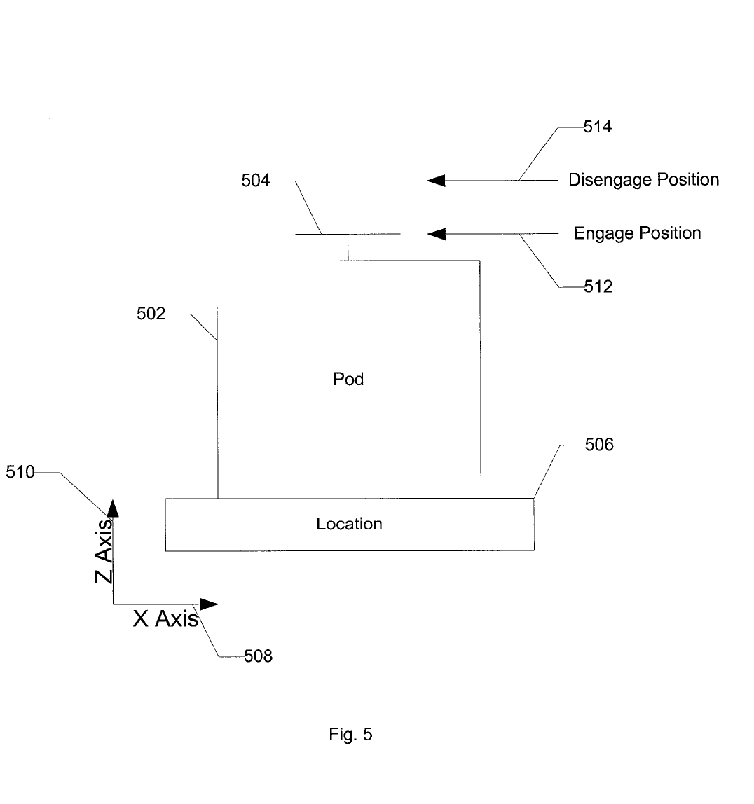

FIG. 5 shows a Pod 502 seated on a Location 504. The Pod 502 has an engagement handle 504. The diagram also shows an x-axis 506 and a z-axis 510. The diagram indicates that when a robot is in an engaged position 512, a gripper mechanism of the robot will be positioned at a level along the z-axis 510 such that it may engage the engagement handle 504 of the Pod 502.

In a disengaged position 514, the gripper mechanism of the robot will be positioned at a level along the z-axis 510 such that, if the Pod 502 were held by the gripper mechanism, the Pod 502 would be lifted clear of all interface mechanisms (not shown) between the Pod 502 and the Location 504. Thus, the Pod 502 would be free move, unobstructed, along the x-axis 508 in the disengaged position 514.

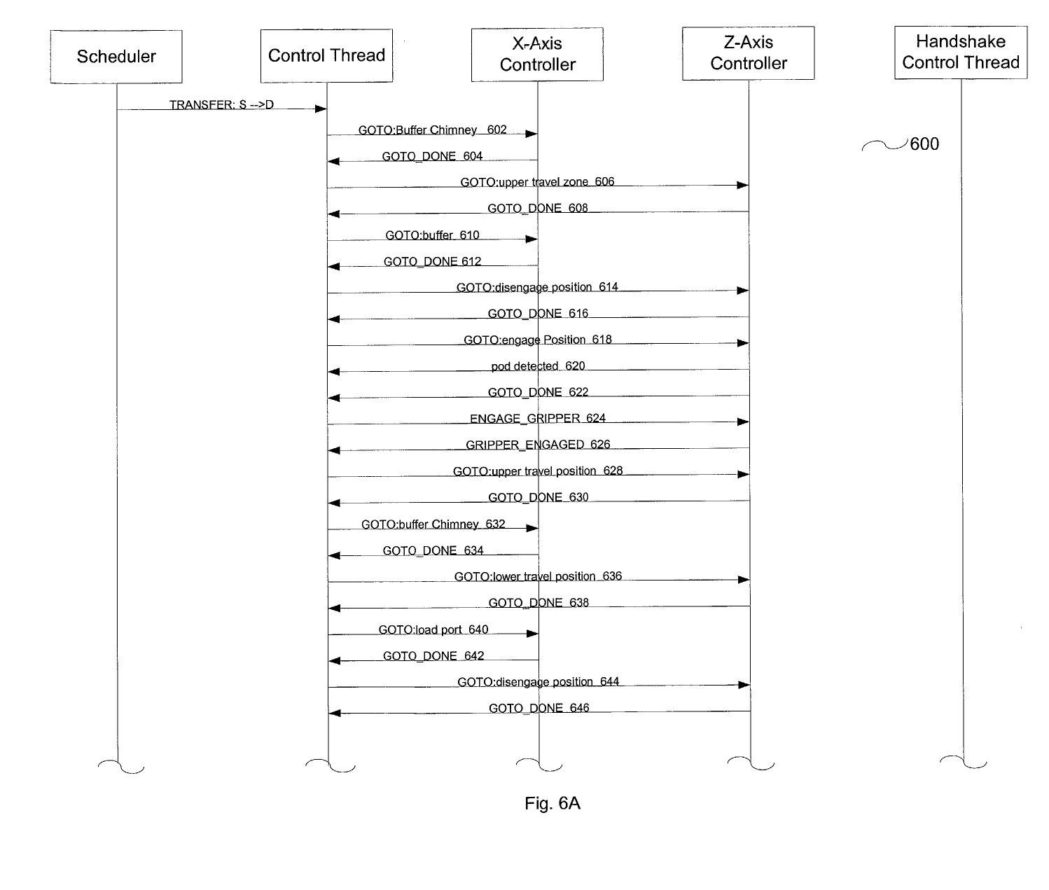

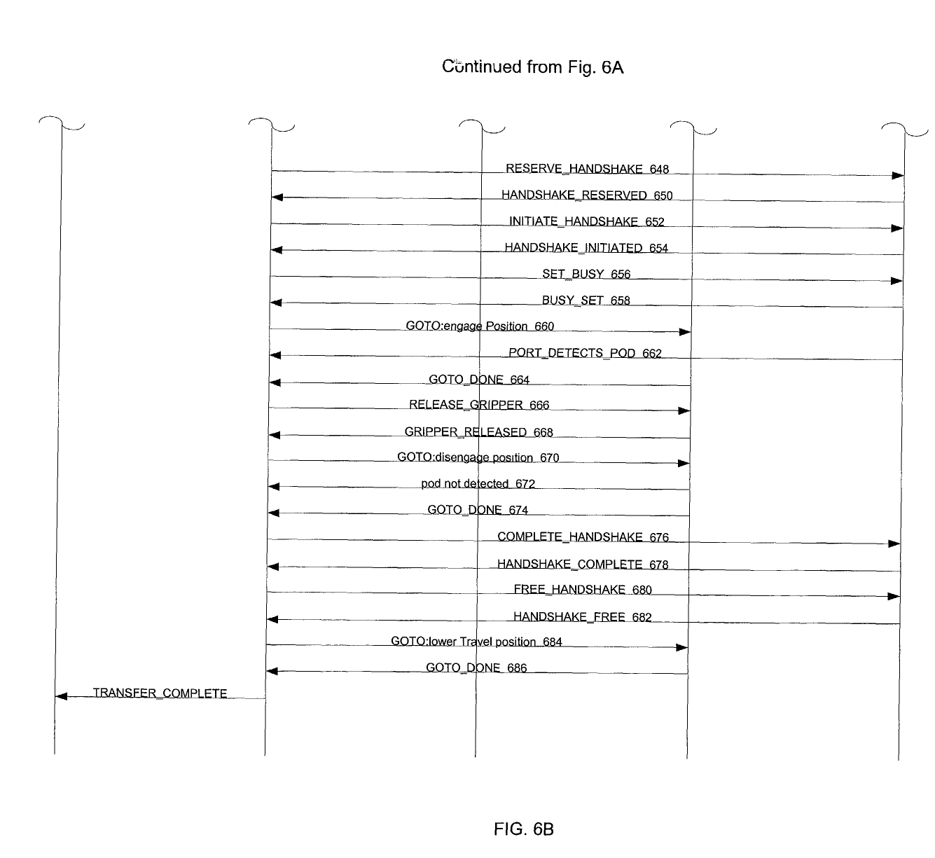

FIG. 6 shows an example of a command sequence 600 the TBCS may issue to accomplish the transfer of a Pod from an upper Static Buffer to a specified load port. Alternate command sequences may be issued by the TBCS to accomplish the same task or various other tasks associated with the TBS. Upon receipt of a TRANSFER:source→destination command from the Scheduler, a GOTO:buffer chimney command 602 is issued to the x-axis controller of the robot transporting the Pod. The x-axis controller responds GOTO DONE 604 to the CLC controller when the movement is complete. Next, the CLC controller issues a GOTO:upper travel zone 606 command to the z-axis controller of the robot transporting the Pod. The z-axis controller responds GOTO_DONE 608 to the CLC controller when the movement is complete. The CLC next issues a GOTO:buffer command 610 to the x-axis controller, and when the movement is complete, the x-axis controller responds GOTO_DONE 612. Next, the CLC issues a GOTO:disengage position command 614, and the robot positions itself just above the Pod. When the movement is complete, the z-axis controller will respond GOTO_DONE 616. The CLC then issues a GOTO:engage position command 618, and the robot positions itself at a level to engage the Pod. If a Pod is present at the Static Buffer, the z-axis controller then issues a Pod detected signal 620 followed by a GOTO_DONE signal 622.

Upon receipt of the Pod detected signal 620 and GOTO_DONE signal 622, the CLC will issue an ENGAGE_GRIPPER command 624. When the CLC receives the GRIPPER_ENGAGED signal 626, the CLC will issue a GOTO:upper travel position command 628. Then, when the z-axis controller responds with a GOTO_DONE signal 630, the CLC will issue a GOTO:buffer chimney command 632 to the x-axis controller.

Upon receipt of the GOTO_DONE signal 634 from the x-axis controller, the CLC controller will issue a GOTO:lower travel position command 636 to the z-axis controller. When the z-axis controller responds GOTO_DONE 638, the CLC controller will issue a GOTO:load port command 640. The x-axis controller will respond with a GOTO_DONE signal 642 command when the robot reaches the load port x-axis location. The CLC controller will then issue a GOTO:disengage position command 644, and the z-axis controller will position the Pod just above the load port and issue a GOTO_DONE signal 646.

The CLC controller will then issue a series of commands to hand-off the Pod to the handshake control thread. The handshake control thread handles communications between the TBCS and the external system. First, the CLC controller will issue a RESERVE HANDSHAKE command 648 and wait for a HANDSHAKE_RESERVED signal 650. Then, an NITIATE_HANDSHAKE command will be issued 652, and a HANDSHAKE_INITIATED signal 654 will be sent in response. Next, a SET_BUSY command 656 will be sent.

In response to receipt of a BUSY_SET signal 658, identifying that the system has reserved the load port for transfer of the Pod, the CLC controller will issue a GOTO:engage position 660 and the robot will lower the Pod onto the load port. The CLC controller will then receive a PORT_DETECTS_Pod signal 662 and a GOTO_DONE signal 664. In response to receipt of the GOTO_DONE signal 664, the CLC controller will issue a RELEASE_GRIPPER command 666.

In response to a GRIPPER_RELEASED signal 668, the CLC controller will issue a GOTO:disengage position command 670. If the Pod was properly deposited and released, a Pod not detected signal 672 and a GOTO_DONE signal 674 will both be received.

Hand-off communications between the TBCS and the transport controller for the specific load port will then be terminated by issuing a COMPLETE_HANDSHAKE command 676. In response, a HANDSHAKE_COMPLETE signal will be received 678 and the CLC controller will issue a FREE_HANDSHAKE command 680.

In response to a HANDSHAKE_FREE signal 682, the CLC controller will issue a GOTO:lower travel position command 684 to move the robot away from the load port and into the lower travel zone. Once the robot has moved to the lower travel zone, the z-axis controller will transmit a GOTO_DONE signal 686. The CLC controller will then identify the transfer of the given Pod as complete.

While FIG. 6 describes commands being issued in a particular sequence, those skilled in the art will understand that other sequences of movements may be employed. Furthermore, numerous commands, such as those related to reservation of the load port and hand-off of the Pod, may be performed at various points within the sequence of steps.

Moreover, those skilled in the art will understand that other similar command sequences may be generated for moving Pods between any of the locations within the TBCS system.

Although the control system has been described with regards to semiconductor manufacturing, the above-described control system may be applied to various manufacturing related fields which utilize automated conveyor systems.

What is claimed is:

1. A control system for a material transport system, comprising:
a controller;
a command queue, said command queue containing commands that control movement in said material transport system;
a defined plurality of movement triggers that cause the controller to examine the command queue and select a command to execute.

2. The control system of claim 1 wherein said controller is comprised of a transport controller, a control logic computer and one or more intelligent drivers.

3. The control system of claim 1, wherein said control logic computer sequences the selection of commands from said command queue.

4. The control system of claim 1 further comprising:
a plurality of pod-in-place sensors adapted to transmit pod-in-place signals.

5. The control system of claim 4, wherein said controller sequences selection of said commands from said command queue based on said pod-in-place signals.

6. The control system of claim 3, wherein said controller sequences selection of successive commands from said command queue based on said preceding command selected.

7. The control system of claim 4, further comprising a tracking system adapted to intermittently determine the locations of pods based on said pod-in-place signals.

8. A control system for transfer and buffering pods within a semiconductor manufacturing facility comprising:
a transportation system;
a transport controller adapted to control movement of said transportation system;
a plurality of location sensors adapted to transmit pod-in-place signals;
a control logic computer connected to said transport controller and adapted to receive a source/destination signal and said pod-in-place signals and issue control commands to said transportation system in response to said source/destination signal and said pod-in-place signals.

9. The control system of claim 8 wherein said control logic computer issues said control commands sequentially.

10. The control system of claim 8, wherein said control logic computer receives said source/destination signals from said transport controller.

11. The control system of claim 8 further comprising:
a scheduler for sequencing said source/destination signals.

12. The control system of claim 11 wherein said scheduler sequences said source/destination signals based on said preceding command selected.

13. The control system of claim 11, wherein said scheduler sequences said source/destination signals based on a current state of said control logic computer.

14. The control system of claim 8, wherein said control logic computer is adapted to store a specific pod with a predetermined distance from a specified destination.

15. A control system for transfer and buffering material in a transport system comprising:
a control logic computer adapted to receive source/destination signals regarding materials in said transport system and cause issuance of control commands in response to said source/destination signals;
a plurality of location sensors connected to said control logic computer to provide data to said control logic computer regarding locations of materials in said transport system.

16. The control system of claim 15 further comprising:
a scheduler for sequencing said control commands.

17. The control system of claim 16 further comprising:
a plurality of pod-in-place sensors adapted to transmit pod-in-place signals.

18. The control system of claim 16 wherein said scheduler sequences said control commands based on said said source/destination signals and said pod-in place signals.
